(19) United States
(12) Patent Application Publication
(10) Pub. No.: US 2022/0337134 A1
(43) Pub. Date: Oct. 20, 2022

(54) DRIVE MOTOR MODULE

(71) Applicant: Nidec Corporation, Kyoto (JP)

(72) Inventors: Daisuke OGASAWARA, Kyoto (JP); Kazuyuki YAMAMOTO, Kyoto (JP); Hiroki YOKOZAWA, Kyoto (JP); Keigo NAKAMURA, Kyoto (JP)

(21) Appl. No.: 17/720,458

(22) Filed: Apr. 14, 2022

(30) Foreign Application Priority Data
Apr. 15, 2021 (JP) 2021-069153

(51) Int. Cl. H02K 11/33; H02P 27/06; H02K 5/24

(52) U.S. Cl. CPC H02K 11/33; H02P 27/06; H02K 5/24; H02K 2213/03; H02K 5/04

(57) ABSTRACT

A drive motor module includes a motor, an inverter electrically connected to the motor, a housing including a motor housing that houses the motor and an inverter housing that houses the inverter, in which the housing includes a wall portion including a first side and a second side opposing each other and directed outside of the housing, N (N is an integer of 2 or more) high rigidity portions provided with a distance therebetween along the first side and having higher rigidity than the wall portion, and a first rib protruding from the wall portion and extending obliquely at a positive angle from first to (N−1)-th high rigidity portions toward the second side when the N high rigidity portions provided along the first side are defined as the first to N-th high rigidity portions in order.

### CROSS-REFERENCE TO RELATED APPLICATIONS

The present application claims priority under 35 U.S.C. § 119 to Japanese Patent Application No. 2021-069153, filed on Apr. 15, 2021, the entire contents of which are hereby incorporated herein by reference.

### 1. FIELD OF THE INVENTION

The present disclosure relates to a drive motor module.

### 2. BACKGROUND

A vibration suppression method for suppressing vibration of a motor itself or vibration transmitted from the motor is conventionally known. The vibration suppression method includes, for example, the following three methods.

The first method is a method of suppressing vibration by reducing the excitation force.

The second method is a method of suppressing vibration by increasing rigidity of a motor or a peripheral portion of the motor.

The third method is a method of suppressing vibration by elasticity of a support portion that supports a motor (vibration source).

Conventionally, the electromagnetic excitation forces of the two types of teeth (the in-phase teeth and the out-of-phase teeth) in the stator cancel each other out, and the excitation force applied to the entire stator is reduced. Thus, vibration of the motor can be suppressed.

Conventionally, the vibration component in the predetermined direction is canceled by controlling the current of the motor, and the vibration of the entire motor is suppressed.

Conventionally, a plurality of reinforcing ribs is provided on a flange portion of a motor frame that houses a motor. The plurality of reinforcing ribs can increase the rigidity of the motor frame. Accordingly, even when vibration from the motor is transmitted to the motor frame, resonance of the motor frame can be suppressed.

Conventionally, a support portion that supports a vibration source (engine) has elasticity. By increasing the spring rigidity of the support portion, vibration from the vibration source can be attenuated.

The motor may be housed in a housing together with an inverter that supplies drive power to the motor to be modularized (unitized).

In addition, the conventional motors can suppress vibration, but cannot completely eliminate the vibration. When these conventional motors are modularized, vibration is inevitably transmitted to the housing, so that the housing may resonate to generate noise.

### SUMMARY

An example embodiment of a drive motor module of the present disclosure includes a motor, an inverter electrically connected to the motor, a housing including a motor housing that houses the motor and an inverter housing that houses the inverter, in which the housing includes a wall portion including a first side and a second side opposing each other and facing outside of the housing, N (N is an integer of 2 or more) high rigidity portions provided with a distance therebetween along the first side and having higher rigidity than the wall portion, and a first rib protruding from the wall portion and extending obliquely at a positive angle from first to (N−1)-th high rigidity portions toward the second side when the N high rigidity portions provided along the first side are defined as the first to N-th high rigidity portions in order, and the first rib protrudes from the wall portion and protrudes from the wall portion, a second rib extending obliquely at a negative angle from the second to N-th high rigidity portions toward the second side. The first rib and the second rib intersect each other at at least one or more points to define an intersection.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a schematic perspective view of a drive motor module according to a first example embodiment of the present disclosure.

FIG. 2 is a view (side view) when viewed in a direction of an arrow A in FIG. 1.

FIG. 3 is a schematic side view of the housing illustrated in FIG. 2.

FIG. 4 is a perspective view of the housing illustrated in FIG. 2.

FIG. 5 is a schematic perspective view of a housing of a drive motor module according to a second example embodiment of the present disclosure.

### DETAILED DESCRIPTION

Hereinafter, drive motor modules according to preferred embodiments of the present disclosure will be described in detail based on example embodiments shown in the accompanying drawings.

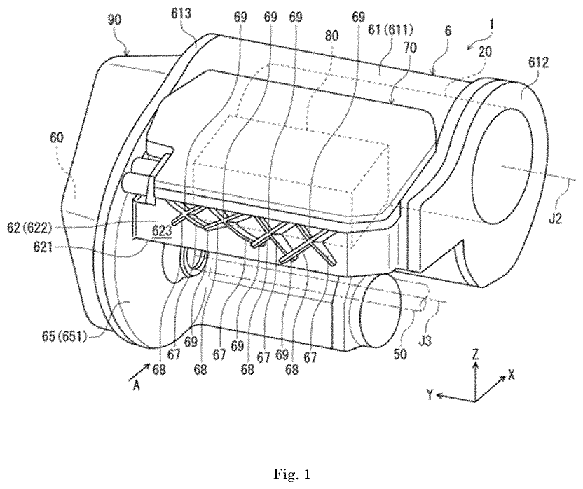

A drive motor module according to the first example embodiment of the present disclosure will be described with reference to FIGS. 1 to 4.

In the following description, the gravity direction is defined based on the positional relationship when the drive motor module is mounted on a vehicle located on a horizontal road surface. In addition, in the drawings, an XYZ coordinate system is shown appropriately as a three-dimensional orthogonal coordinate system. In the XYZ coordinate system, a Z-axis direction corresponds to a vertical direction (i.e., an up-down direction), and a +Z direction points upward (i.e., in a direction opposite to the direction of gravity), while a −Z direction points downward (i.e., in the direction of gravity). The X-axis direction is a direction orthogonal to the Z-axis direction and indicates a front-rear direction of the vehicle on which the drive motor module is mounted. A Y-axis direction is a direction perpendicular to both the X-axis direction and the Z-axis direction, and is a width direction (right-left direction) of the vehicle.

In the following description, unless otherwise specified, a direction (the Y-axis direction) parallel to a motor axis of a motor will be simply referred to by the term “axis direction”, “axial”, or “axially”, radial directions centered on the motor axis will be simply referred to by the term “radial direction”, “radial”, or “radially”, and a circumferential direction centered on the motor axis, i.e., a circumferential direction about the motor axis, will be simply referred to by the term “circumferential direction”, “circumferential”, or “circumferentially”. In the present example embodiment, “one side in the axis direction” is a positive side in the Y-axis direction, and “the other side in the axis direction” is a negative side in the Y-axis direction.

In the present specification, “extending (provided) along” a predetermined direction (or plane) includes not only extending strictly in the predetermined direction but also extending in a direction inclined within a range of less than 45° with respect to the strict predetermined direction.

A drive motor module 1 illustrated in FIG. 1 is mounted on a vehicle using a motor as a power source, such as a hybrid electric vehicle (HEV), a plug-in hybrid electric vehicle (PHV), or an electric vehicle (EV), and is used as the power source. That is, the drive motor module 1 is a drive device.

The drive motor module 1 includes a motor (main motor) 20, an inverter 80, a differential device 60, a housing 6, an inverter cover 70, and a gear cover 90. The drive motor module 1 further includes a deceleration device, an oil pump (none of which are illustrated), and the like.

The motor 20 is accommodated (housed) in the housing 6. The motor 20 includes a rotor that rotates about a motor axis (axis) J2 extending in the horizontal direction, and a stator located radially outside the rotor. The motor 20 of the present example embodiment is an inner rotor type motor, and the rotor rotates when an alternating current is supplied from a battery (not illustrated) to the stator via the inverter 80. In the present example embodiment, the motor axis J2 is parallel to the Y direction.

Oil as a refrigerant circulates inside the motor 20. The motor 20 is thus cooled. The oil is circulated by the operation of the oil pump.

A deceleration device is connected to the rotor of the motor 20. The deceleration device has a function of reducing a rotation speed of the motor 20 to increase torque output from the motor 20 according to a reduction ratio. The deceleration device transfers the torque output from the motor 20 to the differential device 60.

The differential device 60 is connected to the motor 20 via the deceleration device. The differential device 60 is a device that includes a gear (not illustrated) to transfer torque output from the motor 20 to wheels of the vehicle. The differential device 60 is coupled to a drive shaft 50 extending in parallel with the motor axis J2 of the motor 20. The differential device 60 has a function of transferring the torque to the left and right wheels while absorbing the difference in speed between the left and right wheels when the vehicle turns.

As in the motor 20, the inverter 80 is also housed in the housing 6. The inverter 80 is electrically connected to the motor 20. The inverter 80 includes a control element that controls power supplied to the motor 20. The control element is, for example, an IGBT.

The housing 6 includes a motor housing 61 that houses the motor 20, an inverter housing 62 that houses the inverter 80, and a gear housing 65 that houses the gear of the differential device 60.

The housing 6 is an integrally molded product in which the motor housing 61, the inverter housing 62, and the gear housing 65 are integrated. The motor housing 61, the inverter housing 62, and the gear housing 65 may be configured as separate bodies, and the separate bodies may be connected (fixed) to each other.

As illustrated in FIG. 1, the motor housing 61 is disposed apart from the drive shaft 50 in the radial direction thereof, and is disposed apart from the drive shaft 50 in the +X direction in the present example embodiment.

The inverter housing 62 is also disposed apart from the drive shaft 50 in the radial direction thereof, and is disposed apart from the drive shaft 50 in the +Z direction in the present example embodiment.

The gear housing 65 is located on the axis J3 of the drive shaft 50 and is disposed in the +Y direction (one side of the axis J3) relative to the motor housing 61 and the inverter housing 62.

The motor housing 61 has a cylindrical wall portion 611 that surrounds the motor 20 around the motor axis J2. The motor housing 61 has a wall portion 612 that closes the wall portion 611 from the −Y direction and a wall portion 613 that closes the wall portion 611 from the +Y direction. The motor 20 can be housed in a space surrounded by the wall portion 611, the wall portion 612, and the wall portion 613.

The inverter housing 62 has a bottom portion 621 parallel to the XY plane and a side wall portion (wall portion) 622 provided along an edge portion of the bottom portion 621. Then, the inverter 80 can be housed in a space surrounded by the bottom portion 621 and the side wall portion 622.

The inverter cover 70 is attached to the inverter housing from the +Z direction so as to cover the inverter 80. Accordingly, the inverter 80 can be protected.

The gear housing 65 has a funnel-shaped wall portion 651 centered on the axis J3. The gear of the differential device 60 can be housed inside the wall portion 651.

In addition, a gear cover 90 is attached to the gear housing 65 from the +Y direction so as to cover the gear of the differential device 60. Accordingly, the gear can be protected.

As described above, the motor 20 is mounted on the drive motor module 1. When the motor 20 operates, vibration also occurs accordingly. This vibration is transmitted to the housing 6. Depending on the vibration frequency at this time, the housing 6 may resonate. Of the housing 6, resonance is likely to occur particularly at the inverter housing 62. One of the reasons is that the side wall portion 622 has a thin plate shape.

When the inverter housing 62 resonates, for example, the side wall portion 622 may cause film resonance, the entire inverter housing 62 may vibrate in the vertical direction, vibrate in the horizontal direction, or vibrate so as to be twisted around a predetermined axis, thereby generating noise. In addition, the noise is considered to impair the comfort of the automobile.

Therefore, the drive motor module 1 is configured to suppress resonance of the inverter housing 62 in order to solve such a defect (particularly, resonance of the inverter housing 62). Hereinafter, this configuration and operation will be described.

The vibration source when the housing 6 resonates is not limited to the motor 20.

As described above, the inverter housing 62 has the side wall portion 622 constituting part of the inverter housing 62. As illustrated in FIGS. 1 to 3, the side wall portion 622 faces outside of the housing 6. In the present example embodiment, the side wall portion 622 has a rib forming face 623 that faces in the −X direction and on which a first rib 67 and a second rib 68 to be described later are formed.

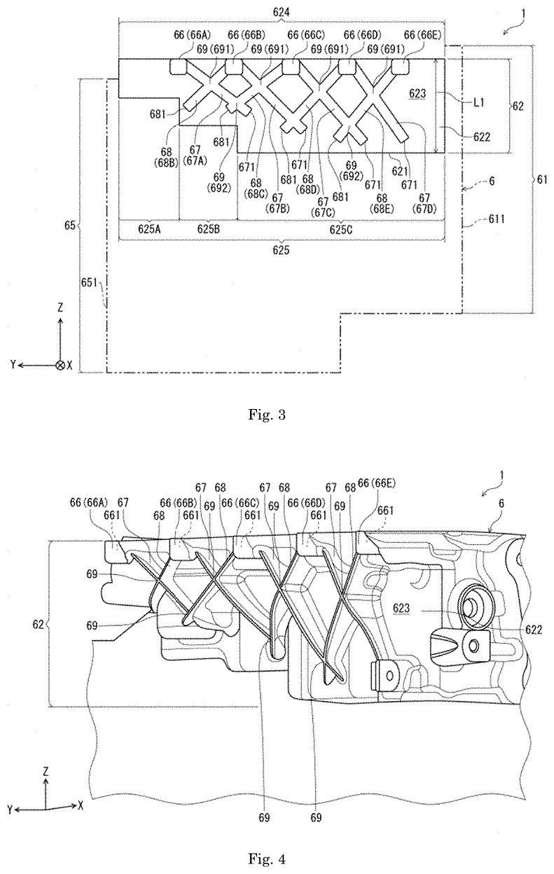

As illustrated in FIG. 3, the rib forming face 623 has a first side 624 located on the upper side, and a second side 625A, a second side 625B, and a second side 625C located below the first side 624. Hereinafter, the second side 625A, the second side 625B, and the second side 625C may be collectively referred to as a “second side 625”.

The first side 624 is parallel to the Y direction.

As in the first side 624, the second side 625A, the second side 625B, and the second side 625C are also parallel to the Y direction. Therefore, the first side 624 and the second side 625A to the second side 625C are in a positional relationship of facing each other.

In addition, the second side 625A to the second side 625C are each disposed to be shifted in the Z direction in a stepwise manner, the second side 625A is located in the most+Z direction, the second side 625C is located in the most −Z direction, and the second side 625B is located between the second side 625A and the second side 625C.

Of the second side 625A to the second side 625C, the second side 625C is the longest, and occupies, for example, 50% or more of the total length of the second side 625A to the second side 625C.

The inverter housing 62 includes a high rigidity portion 66, a first rib 67, and a second rib 68.

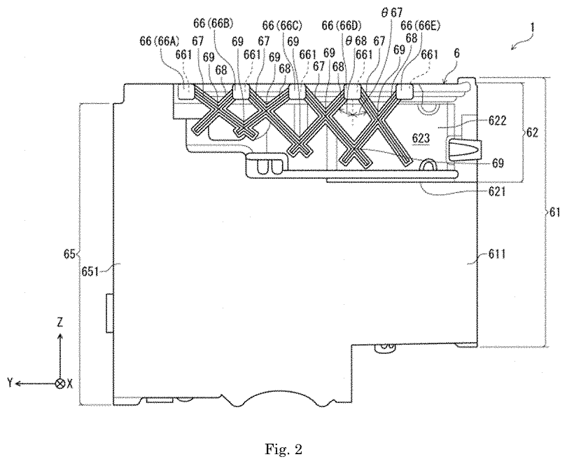

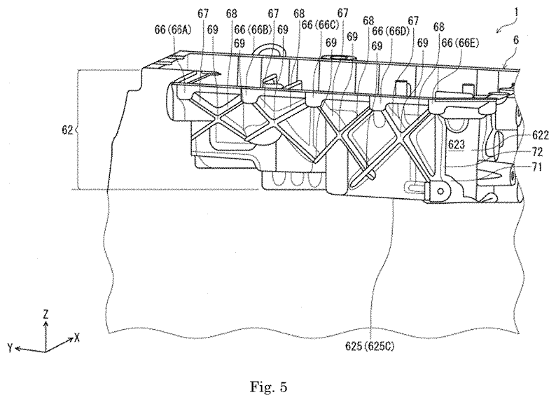

The high rigidity portion 66 is a portion having higher rigidity than the side wall portion 622. As illustrated in FIGS. 2 and 4, the high rigidity portion 66 is provided to protrude in the −X direction from the rib forming face 623 of the side wall portion 622. As a result, the high rigidity portion 66 has higher rigidity than the side wall portion 622.

N (N is an integer of 2 or more) high rigidity portions 66 are provided with a distance therebetween along first side 624. In the present example embodiment, N is “5” as an example. When the five high rigidity portions 66 are defined as the first to fifth high rigidity portions 66 in order from the −Y direction, the first high rigidity portion 66 may be referred to as a “high rigidity portion 66A”, the second high rigidity portion 66 may be referred to as a “high rigidity portion 66B”, the third high rigidity portion 66 may be referred to as a “high rigidity portion 66C”, the fourth high rigidity portion 66 may be referred to as a “high rigidity portion 66D”, and the fifth high rigidity portion 66 may be referred to as a “high rigidity portion 66E”.

A screw hole (female screw) 661 along the Z direction is formed in each high rigidity portion 66. When the inverter cover 70 is attached to the inverter housing 62, a screw portion (not illustrated) of a bolt penetrating the inverter cover 70 can be connected to the screw hole 661. As a result, the inverter cover 70 can be firmly fixed to the inverter housing 62. In this manner, each of the high rigidity portions 66 can be used as a fastening portion to which the inverter cover 70 is fastened.

The use of each high rigidity portion 66 is not limited to the fastening portion for fastening the housing 6 and the inverter cover 70, and may be, for example, a fastening portion for fastening the housing 6 and another structure such as a frame of an automobile or the like.

Each of the first rib 67 and the second rib 68 is provided to protrude in the −X direction from the rib forming face 623 of the side wall portion 622.

Although depending on the size of the inverter housing 62, the width of each of the first rib 67 and the second rib 68 is, for example, preferably 5 mm or more, and more preferably 5 to 10 mm. The height (protrusion height) of each of the first rib 67 and the second rib 68 is, for example, preferably 15 mm or more, and more preferably 15 to 25 mm.

As illustrated in FIG. 2, the first rib 67 obliquely extends from the first to (N−1)-th high rigidity portions 66, that is, the high rigidity portion 66A, the high rigidity portion 66B, the high rigidity portion 66C, and the high rigidity portion 66D, at a positive angle θ67 (hereinafter, simply referred to as an “angle θ67”) toward the second side 625. Here, the “positive angle θ67” refers to an angle of the rib with predetermined inclination counterclockwise with respect to the Z direction when viewed from the −X direction as illustrated in FIG. 2. The angles θ67 of the first ribs 67 may be the same as or different from each other.

Hereinafter, the first rib 67 extending obliquely from the high rigidity portion 66A may be referred to as a “first rib 67A”, the first rib 67 extending obliquely from the high rigidity portion 66B may be referred to as a “first rib 67B”, the first rib 67 extending obliquely from the high rigidity portion 66C may be referred to as a “first rib 67C”, and the first rib 67 extending obliquely from the high rigidity portion 66D may be referred to as a “first rib 67D” (see FIG. 3).

The second rib 68 extends obliquely from the second to N-th high rigidity portions 66, that is, the high rigidity portion 66B, the high rigidity portion 66C, the high rigidity portion 66D, and the high rigidity portion 66E, toward the second side 625 at a negative angle θ68. Here, the “negative angle θ68” refers to an angle of the rib with predetermined inclination clockwise with respect to the Z direction when viewed from the −X direction as illustrated in FIG. 2. The angles θ68 of the second ribs 68 may be the same as or different from each other.

Hereinafter, the second rib 68 extending obliquely from the high rigidity portion 66B may be referred to as a “second rib 68B”, the second rib 68 extending obliquely from the high rigidity portion 66C may be referred to as a “second rib 68C”, the second rib 68 extending obliquely from the high rigidity portion 66D may be referred to as a “second rib 68D”, and the second rib 68 extending obliquely from the high rigidity portion 66E may be referred to as a “second rib 68E” (see FIG. 3).

As described above, since the side wall portion 622 has a thin plate shape, the inverter housing 62 easily resonates. In the drive motor module 1, the thin plate-shaped side wall portion 622 can be reinforced by the first rib 67 and the second rib 68.

In addition, the first rib 67 and the second rib 68 are provided to extend from the high rigidity portion 66. As a result, the rigidity of the first rib 67 and the second rib 68 is further enhanced.

In the drive motor module 1, the reinforcement of the side wall portion 622 by the first rib 67 and the second rib 68, and the high rigidity of the first rib 67 and the second rib 68 by the high rigidity portion 66 are combined, and thus, it is possible to sufficiently suppress various vibrations in which the inverter housing 62 vibrates in the vertical direction, vibrates in the horizontal direction, or vibrates so as to be twisted around a predetermined axis at the time of resonance of the housing 6.

As illustrated in FIG. 3, an end portion 671, of each first rib 67, toward the second side 625 is away from the second side 625. Similarly, an end portion 681, of each second ribs 68, toward the second side 625 is also away from the second side 625.

In order to suppress the vibration in the vertical direction of the inverter housing 62 described above, it is sufficient that the high rigidity portion 66 is provided on the first side 624 side. Therefore, it is not necessary to provide the high rigidity portion such as the high rigidity portion 66 on the second side 625 and connect the end portion 671 of the first rib 67 and the end portion 681 of the second rib 68 to the high rigidity portion.

When the distance from the first side 624 to the second side 625C is L1, the end portion 671 of each first rib 67 and the end portion 681 of each second rib 68 are located within a range of 50% to 90% of the distance L1. As a result, each of the first ribs 67 and each of the second ribs 68 can be extended as long as possible to reinforce the side wall portion 622. This reinforcement contributes to suppressing vibration of the inverter housing 62.

As illustrated in FIGS. 2 to 4, the first rib 67 and the second rib 68 intersect each other at at least one or more locations to form an intersection 69. In the present example embodiment, the first rib 67A intersects the second rib 68B and the second rib 68C to form two intersections 69. The first rib 67B intersects the second rib 68C and the second rib 68D to form two intersections 69. The first rib 67C intersects the second rib 68D and the second rib 68E to form two intersections 69. The first rib 67D intersects the second rib 68E to form one intersection 69.

Due to such intersection, the first rib 67 and the second rib 68 form a grid-like rib as a whole, and the rib forming face 623 of the inverter housing 62 can be substantially uniformly reinforced. As a result, various vibrations of the inverter housing 62 can be sufficiently suppressed at the time of resonance of the housing 6.

The intersection 69 includes a first intersection 691 disposed at the center portion between the first side 624 and the second side 625 and a second intersection 692 disposed closer to the second side 625 than the first intersection 691. Here, the “center portion between the first side 624 and the second side 625” is a portion where the vibration amplitude is considered to be maximized when the side wall portion 622 (rib forming face 623) causes film resonance, that is, vibrates (single vibrates) in the X direction.

In the present example embodiment, the first intersection 691 includes an intersection of the first rib 67A and the second rib 68B, an intersection of the first rib 67B and the second rib 68C, an intersection of the first rib 67C and the second rib 68D, and an intersection of the first rib 67D and the second rib 68E.

The second intersection 692 includes an intersection between the first rib 67A and the second rib 68C, an intersection between the first rib 67B and the second rib 68D, and an intersection between the first rib 67C and the second rib 68E.

By disposing the first intersection 691 at the center portion between the first side 624 and the second side 625, the center portion is reinforced by the first intersection 691. As a result, vibration (that is, film resonance) having the maximum vibration amplitude at the center portion described above is less likely to occur, and resonance suppression can be achieved.

The second example embodiment of a drive motor module of the present disclosure will be described with reference to FIG. 5, but differences from the above-described example embodiment will be mainly described, and description of similar matters will be omitted.

As illustrated in FIG. 5, the housing 6 includes a protrusion 71 and a third rib (rib) 72.

The protrusion 71 is formed so as to protrude in the −X direction from the vicinity of the second side 625 (second side 625C) of the rib forming face 623 (side wall portion 622). The protrusion 71 is, for example, a fastening portion to which an automobile component is fastened.

As in the first rib 67C and the second rib 68E, the third rib 72 is formed to protrude in the −X direction from the rib forming face 623. The third rib 72 extends from the high rigidity portion 66E closest to the protrusion 71 among the high rigidity portion 66A to the high rigidity portion 66E, and is connected to the protrusion 71. In the present example embodiment, the third rib 72 is formed along the Z direction.

Such a third rib 72 together with the first rib 67C and the second rib 68E can reinforce the side wall portion 622 more firmly. As a result, the film resonance in the side wall portion 622 described above can be further suppressed.

Although the drive motor module of the present disclosure is described above with reference to the illustrated example embodiment, the present disclosure is not limited thereto, and each unit constituting the drive motor module can be replaced with a unit having any configuration capable of exhibiting similar functions. Further, any component may be added.

The drive motor module of the present disclosure may be a combination of any two or more configurations (features) of the above example embodiments.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A drive motor module comprising:
a motor;
an inverter electrically connected to the motor;
a housing including a motor housing that houses the motor and an inverter housing that houses the inverter; wherein
the housing includes:
a wall portion including a first side and a second side opposing each other and facing outside of the housing;
N high rigidity portions provided with a distance therebetween along the first side and having higher rigidity than the wall portion, where N is an integer of 2 or more; and
when the N high rigidity portions provided along the first side are defined as first to N-th high rigidity portions in order, a first rib protruding from the wall portion and extending obliquely at a positive angle from the first to (N−1)-th high rigidity portions toward the second side; and
a second rib protruding from the wall portion and extending obliquely at a negative angle from the second to N-th high rigidity portions toward the second side; and
the first rib and the second rib intersect each other at at least one or more points to define an intersection.

2. The drive motor module according to claim 1, wherein the intersection includes an intersection at a center portion between the first side and the second side.

3. The drive motor module according to claim 1, wherein when an intersection in the center portion is defined as a first intersection, the intersection includes a second intersection closer to the second side than the first intersection.

4. The drive motor module according to claim 1, wherein end portions, of the first rib and the second rib, toward the second side are each away from the second side.

5. The drive motor module according to claim 4, wherein when a distance from the first side to the second side is L1, the end portions of the first rib and the second rib, toward the second side, are each located within a range of about 50% to about 90% of the distance L1.

6. The drive motor module according to claim 1, wherein each of the high rigidity portions is a portion protruding from the wall portion.

7. The drive motor module according to claim 1, wherein each of the high rigidity portions is a fastening portion to which the housing and another structure are fastened.

8. The drive motor module according to claim 1, wherein the wall portion is a portion of the inverter housing.

9. The drive motor module according to claim 8, further comprising:
an inverter cover attached to the housing to cover the inverter housed in the inverter housing; wherein
each of the high rigidity portions is a fastening portion to which the inverter cover is fastened.

10. The drive motor module according to claim 1, further comprising:
a protrusion protruding from a vicinity of the second side of the wall portion; and
a rib protruding from the wall portion, extending from any, of the first to N-th high rigidity portions, closest to the protrusion, and connected to the protrusion.
